(19) United States
(12) Patent Application Publication
(10) Pub. No.: US 2014/0042170 A1
(43) Pub. Date: Feb. 13, 2014

(54) MULTI-USE COOKING SYSTEM

(71) Applicant: Felipe Correa, Austin, TX (US)

(72) Inventor: Felipe Correa, Austin, TX (US)

(21) Appl. No.: 13/755,980

(22) Filed: Jan. 31, 2013

Related U.S. Application Data
(60) Provisional application No. 61/593,283, filed on Jan. 31, 2012.

(51) Int. Cl. A47J 27/04; A47J 27/00

(52) U.S. Cl. CPC A47J 27/04; A47J 27/002
USPC 220/573.1

(57) ABSTRACT

A multi-use cooking system for reducing splash and managing steam release while cooking a food item in a cooking vessel is provided. The cooking system comprises a lid having at least one opening portion allowing a user to open and close the opening portion to regulate steam release. A splashguard is attached to the lid by a locking device which allows the splashguard to be securely attached and separated and reattached to the lid. A lid edge forms the periphery of the cooking system and allows the cooking system to be placed on a cooking vessel while cooking a food item.

### CROSS-REFERENCE TO RELATED APPLICATIONS

This application claims the benefit of U.S. provisional patent application 61/593,283 filed on Jan. 31, 2012, which is hereby incorporated by reference in its entirety.

### FIELD OF THE INVENTION

The present disclosure relates in general to the field of cooking, and more particularly to a cooking system for reducing splash and managing steam release while cooking a food item.

### BACKGROUND

Conventional cooking lids are designed to cover cooking containers—such as a saucepan, skillet or pot—to allow heat and/or steam to remain in the cooking vessel while cooking. Conventional lids may prevent the splashing that occurs while cooking at high heat but often do not allow the heat and/or steam to dissipate.

Conventional cooking splashguards (also called a wire mesh, anti-splash lid, or splatter screen) are designed to cover cooking containers to reduce the amount of splash that may occur from cooking, for example on a stovetop. However, splashguards often do not contain the heat and/or steam in the cooking vessel.

Conventional steaming devices used in or on top of cooking containers are designed for cooking with steam. The steaming device is placed on top of or in a cooking vessel with boiling water and the steam from the boiling water cooks food placed on top of or in the steaming device. However, most stovetop steamers are not integrated with other kitchen tools and may be difficult to store. Further, in some cases, stovetop steamers used by placing the steamer inside a pot are often designed without a lid for steam regulation.

### BRIEF DESCRIPTION OF THE DRAWINGS

For a more complete understanding of the disclosed subject matter and advantages thereof, reference is now made to the following brief descriptions set forth below when taken in conjunction with the accompanying drawings in which like reference numbers indicate like features and wherein:

FIG. 1 is a diagram showing a top view of an embodiment of the disclosed cooking system;

FIG. 2 is a diagram showing a side view of an embodiment of the disclosed cooking system;

FIG. 3 is a diagram showing a side view of an embodiment of the disclosed cooking system showing functionality;

FIG. 4 is a diagram showing a top angle view of an embodiment of the disclosed cooking system showing part of the device removed for cleaning purposes;

FIG. 5 is a diagram showing a top angle view of an embodiment of the disclosed cooking system showing an optional metal accessory;

FIGS. 6A and 6B are diagrams showing a side angle view of alternative lid opening embodiments; and

FIG. 7 is a diagram of an embodiment of the disclosed cooking system with a connected baking broiling pan

### DETAILED DESCRIPTION

The following description is not to be taken in a limiting sense, but is made for the purpose of describing the general principles of the present disclosure. The scope of the present disclosure should be determined with reference to the claims. Exemplary embodiments of the present disclosure are illustrated in the drawings, like numbers being used to refer to like and corresponding parts of the various drawings.

The disclosed subject matter describes a multi-purpose cooking system that provides for various cooking functionalities and may be used as a cooking lid and splashguard and/or as a cooking vessel and food steamer. Technical advantages of the disclosed multi-purpose cooking system allow a user to perform multiple cooking disciplines with one device, thus allowing a user to save time by moving from tool to tool easily by attaching and/or reattaching the lid and splashguard components (in addition to optional accessories for steaming food and baking/broiling food) and saving valuable kitchen space by replacing other cooking devices with the disclosed multi-purpose cooking tool. And when coupled together, the lid and splashguard form one working piece. Further, while the disclosed cooking system is described with reference to use on a stovetop, one skilled in the art may readily use the cooking system in any cooking application such as in an oven for baking or broiling.

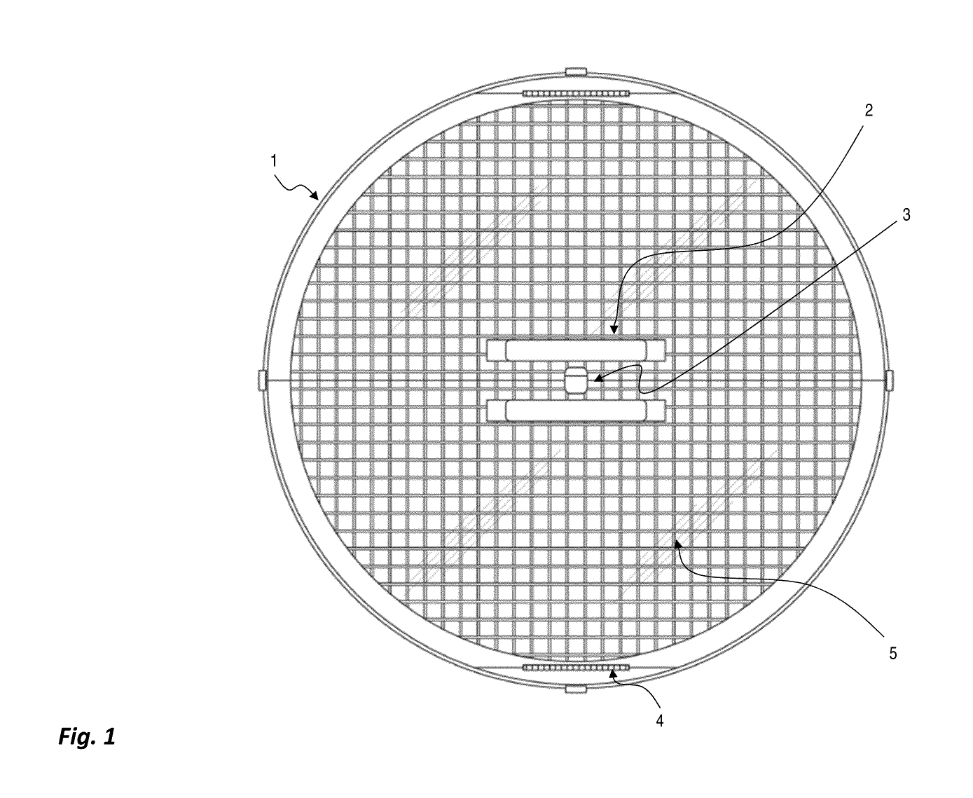

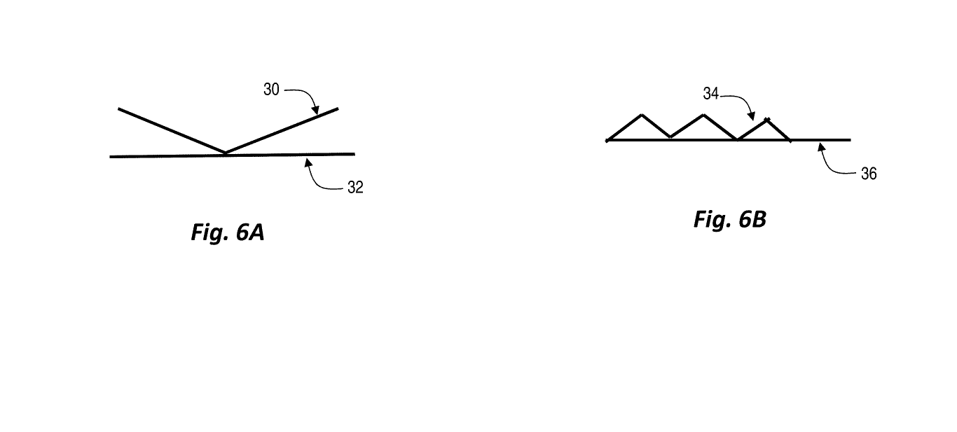

FIG. 1 is drawing showing a top view of a cooking system embodiment emphasizing hardware construction and examples. The cooking system described and shown in the following figures is designed to cover a saucepan, skillet, or pot, while cooking an item and may be made to fit any size or dimension of such, this may include a universal lid design that can fit multiple cooking vessels. A lid edge positioned around the periphery of the cooking system allows the cooking system to be placed securely above a saucepan, skillet, or pot while cooking a food item, shown in FIG. 1 as peripheral lid edge 1. The cooking system may include, but is not limited to, a plurality of lids, lid opening portions (such as glass portion 5), lid handles (such as lid handle 2), lid locking device(s) (such as lock 3), hinges (such as hinge 4), and a splashguard attached below the glass lid. The lid may be glass as shown in FIG. 1 for the descriptive purpose of showing the splashguard attached below; however, the lid itself may be transparent, nontransparent, or semitransparent and may be made of any heat tolerant material including plastics or metals. As shown in FIG. 1, lid handle 2 is positioned in the center of the lid; however, this handle may also be positioned more proximate the peripheral of the lid itself depending on the position and size of the opening portions of the glass lid (see FIG. 6A).

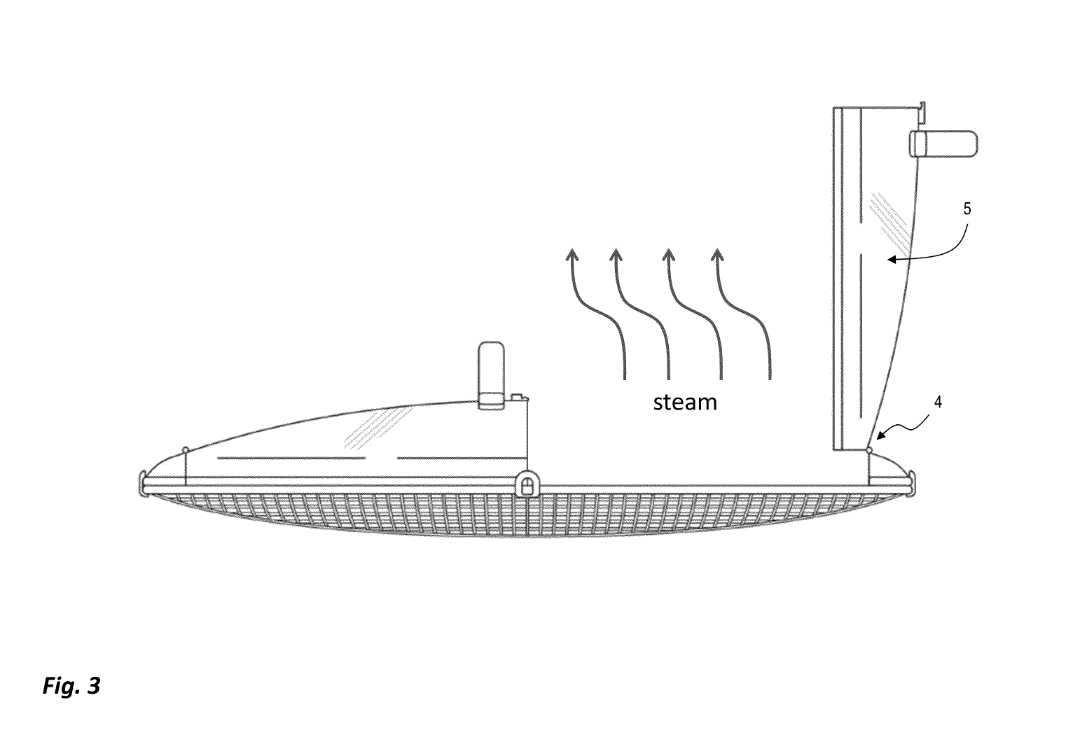

Hinge 4 operates to allow glass portion 5 to lift up and allow steam to escape while the splashguard remains in place (see FIG. 3 for an example of glass portion 5 in the up position) and the user is able to regulate/manage the amount of steam released during cooking. In this diagram, glass portion 5 is approximately half of the total lid size, with a dual glass opening portion the same size and shape covering the other half of the lid, and hinge 4 allows glass portion 5 to open outwardly from the center of the lid. Thus, the vessel shown in the figures of this disclosure shows two glass portions comprising the entire lid surface area which may be opened to expose the splashguard for full steam release from the cooked item while keeping the splash created from the food being cooked inside the vessel and beneath the splashguard. When closed, locking device 3 locks both opening portions of the lid together thus unifying and integrating both sides of the top glass lid to create a single solid glass lid portion. In one example, the locking device may be incorporated into each of the handles so that when the two lid portions shown are down the handles come together and lock into place allowing the lid to be easily handled (i.e. placed on or removed from a cooking vessel); however, other known locking mechanisms may be used and positioned/incorporated on the lid.

An advantage using two glass portions is to simplify operating the lid portion of the cooking system. Two glass portions may counter balance each other in any position, which keeps the lid(s) steady. Also, the two glass portions should be big enough that if fully opened they create a large enough opening to allow food to be placed directly on the splashguard so that it may be steamed. However, the opening glass portion size and shape may vary depending on the amount of steam desired to be released and may also include a plurality of glass opening portions of different sizes and shapes including the size of the opening available for steaming food. Some example sizes and shapes of the opening glass portion include but are not limited to two 25% lid coverage glass portions, and an accordion type lid that slides open to regulate heat or an out-in type lid that has the handles on the outside and hinges on the inside (Accordion and Out-in types are both shown in FIGS. 6A and 6B).

When attached, the lid component and splashguard component of the disclosed subject matter may form a cooking vessel in which food items may be placed. In this capacity, the splashguard acts as cooking platform and the lid component may be used to manage the amount of steam released. Thus, the disclosed cooking system, comprising lid component and splashguard component, may be used to cover a cooking item in a saucepan or the like and may also be used to cook an item above a saucepan or the like.

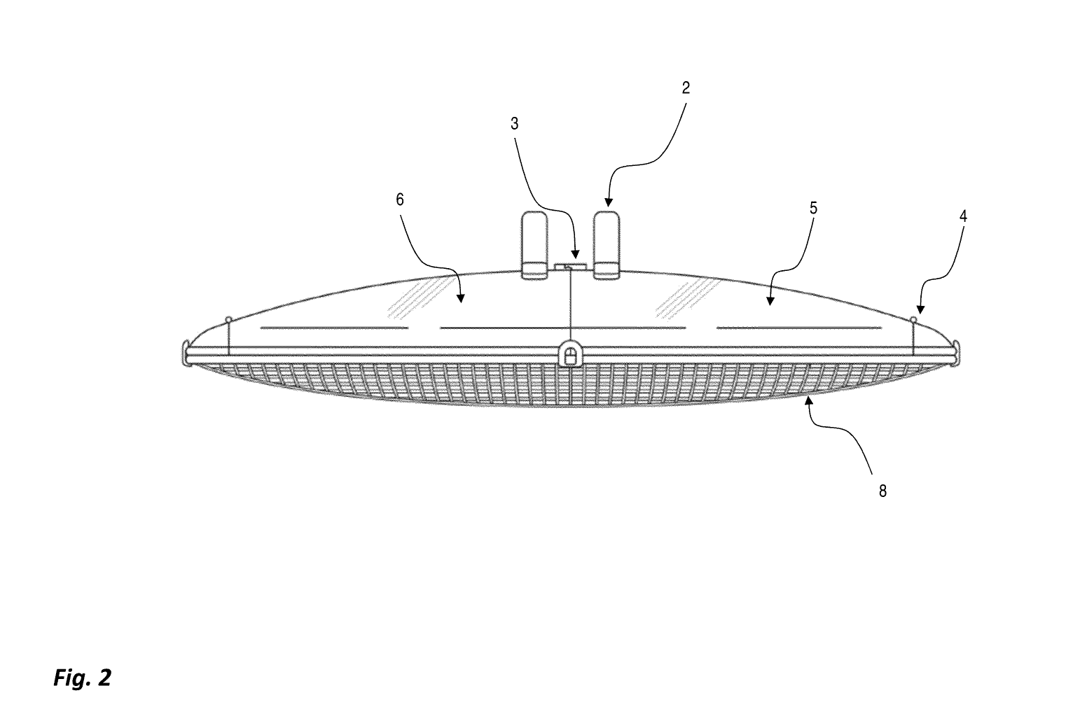

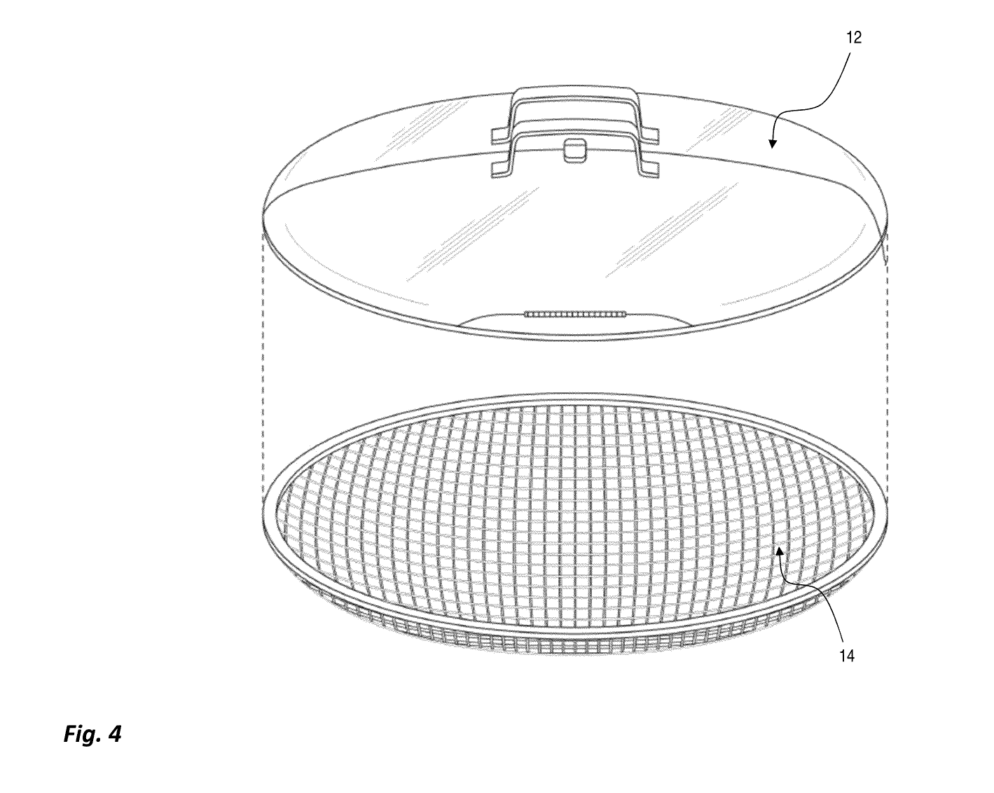

FIG. 2 is a drawing showing a side view of the cooking system showing in FIG. 1. This view shows how the lid may appear while placed on a cooking vessel—with glass (or other material) lid portion 6 (comprising glass portion 5 as well as the rest of the top glass portion of the lid) positioned on splashguard portion 8. As shown, the splashguard and lid portions are directly attached and form a cooking vessel in which a food item may be placed. In one embodiment, such as that shown in FIG. 4, the lid portion and splashguard portion may be conveniently separated. Again, the lid may include, but is not limited to, a plurality of lids, lid handles, lid locking device(s), hinges, a splashguard connected to a lid, and a locking device that connects splashguard to lid(s).

FIG. 3 is a drawing showing a side view of the cooking system of FIG. 1 with a portion of the glass lid (glass portion 5 of FIGS. 1 and 2) open. This drawing helps depict likely functionalities of the cooking system allowing use as a conventional lid when lid(s) are closed (such as that shown in FIG. 2), a splashguard when lid(s) are open, and a steamer if lid(s) are open and/or closed (such as that shown in FIG. 3 with one portion of the glass lid open allowing steam from the cooked item to escape). In actual use and depending on the design, any combination or percentage of the lid portion may be open according to cooking needs. In FIG. 3, only on half of glass portion 5 is in open position; however, in other embodiments any number of glass portions may have opening functionality and may be used in combination to increase or decrease the amount of steam released. Although not shown, the lid may balance open because it opens greater than 90 degrees or the lid may be locked in the open position using, for example, a clasp, hinge locking mechanism, or other known locking mechanism.

FIG. 4 is a drawing showing a top angle view of the cooking system with a handle(s) and hinge (hardware) configuration embodiment consistent with those shown in FIGS. 1, 2, and 3. More specifically, this drawing shows a removable splashguard 14 detached from lid 12 to allow for cleaning of the lid and splashguard separately or together. Examples of lid and splashguard attaching mechanisms include screwing the lid and splashguard together using threads on each, clasping/clamping the lid and splashguard together, or snapping the lid and splashguard together.

In the above description and corresponding figures the splashguard shown is a typical wire mesh splashguard consistent with those known in the art; however, alternative splashguard embodiments may be made of perforated metal, perforated plastics and/or a combination of both.

The lid may be constructed of sufficiently rigid and strong material such as high-strength plastic, glass, metal, and the like. Further, one skilled in the art could make the various components of the lid of different materials while remaining consistent with the spirit of this disclosure.

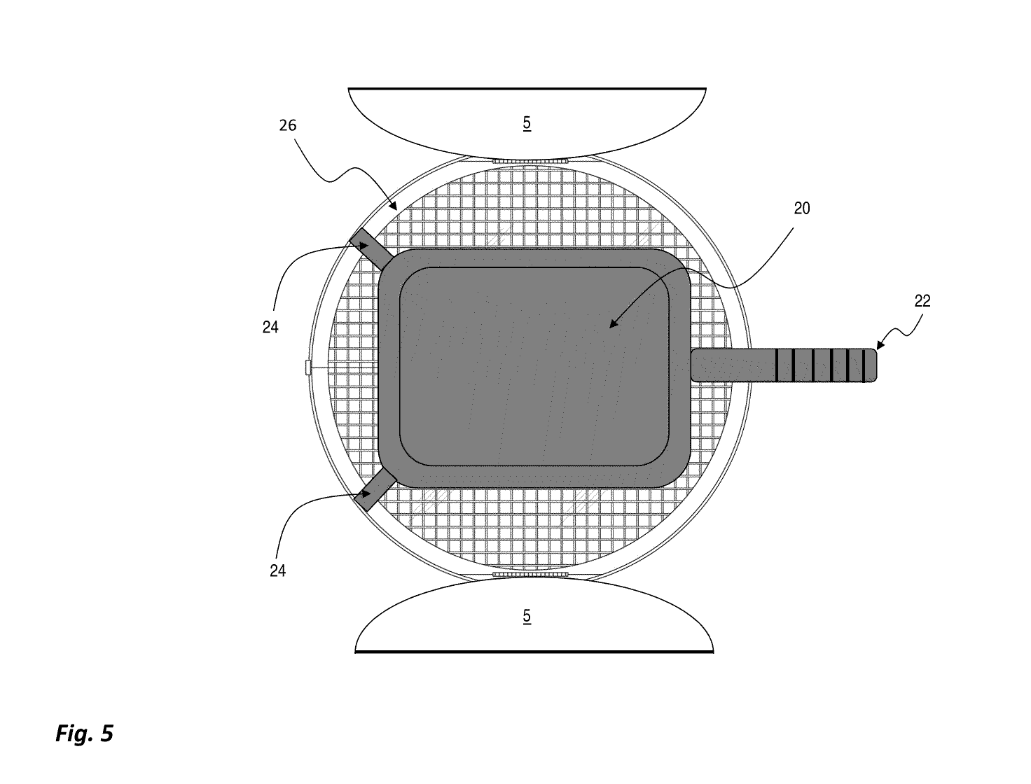

FIG. 5 is a drawing showing a top angle view of an embodiment of the disclosed cooking system with an optional metal pan (or alternative material) accessory(s) for cooking. Optional metal accessory 20 may be placed on or in the splashguard when the lid is in the open position, or may be a more permanent insert positioned between the splashguard and the opening lid portions (shown as open lid portions 5 in FIG. 5). In other words, the accessory may sit and/or attach to the splashguard peripheral rim or be placed on the splashguard itself. Importantly, while described as metallic, the accessory may be made of any material such as wood—for example a cedar wood insert/block used to steam fish. The metal accessory is a mold designed to fit in the open space between the main lid (comprising the splashguard) and the open portions during cooking - in other words, the metal accessory sits above and on top of the splashguard so that it is heated by the steam from the underlying pot/pan thus turning the lid into a low heat pan. Metal accessory arms 24 lay on top of or hook onto cooking device edge/lip 26 and metal accessory arm 22 allows the accessory to be positioned on and removed from the cooking device. Food may be placed on the metal accessory and heat from steam formed from food/water in the pot/pan below the cooking system and/or food on the splashguard is used to melt solids to liquid (such as melting butter or sugar), to heat foods (such as baby food), to steam fish and other solids, and to infuse foods. An example of infusion of food is to cook aromatic foods in a typical saucepan, skillet, or pot while the lid sits on top of the cooking vessel and the aromatic food being cooked releases scents and flavors that impregnate whatever food may be on top of the splashguard whether or not on top of an accessory (such as accessory 20).

FIGS. 6A and 6B are drawings showing side angle views of alternative lid opening embodiments. FIG. 6A shows an out-in opening and FIG. 6B shows an accordion opening. In the out-in opening embodiment shown in FIG. 6A, the opening portions of the lid, opening portions 30, open from the outside (or inwardly) to expose underlying splashguard 32. Thus, in one embodiment the opening hinges may be placed in the center of the lid and handles may be positioned more proximate the outside peripheral of the lid—in contrast to the lid embodiment shown in FIGS. 1 through 5 which have an in- out opening design where the lids open from the center (or outwardly) and handles are positioned more proximate the center of the cooking system.

In the accordion embodiment shown in FIG. 6B the lid operates in an accordion design to fluctuate and control the amount of steam released. In this design, the lid may open using only one handle and the user slides opening portion 34 open to expose underlying splashguard 36 (instead of lifting the lid as described above).

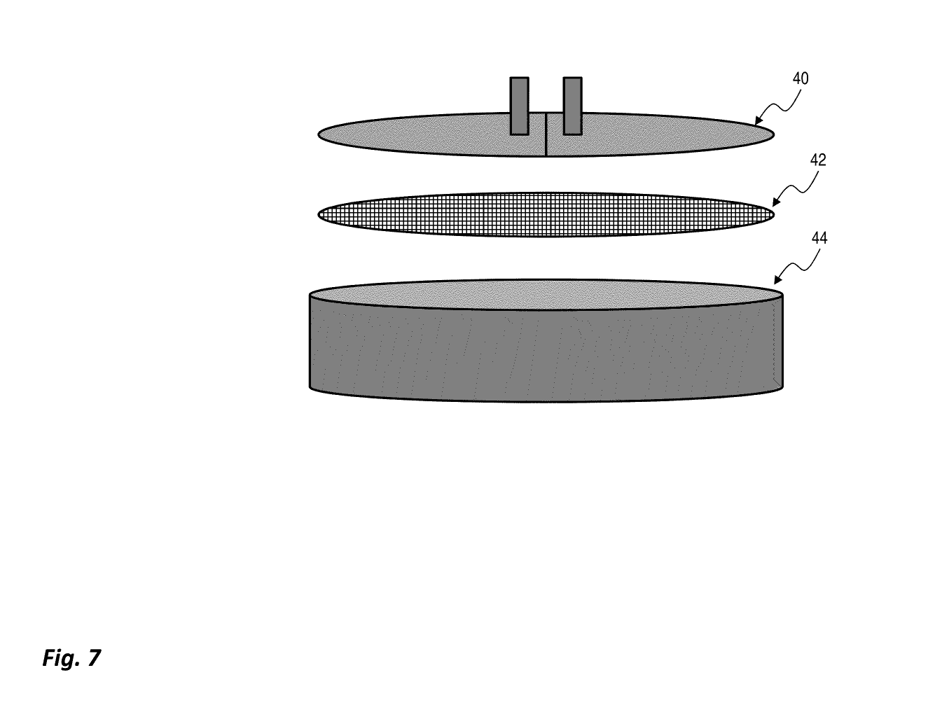

FIG. 7 is a diagram of an embodiment of the disclosed cooking system with a connected baking broiling pan. Baking/broiling pan 44 connects to splashguard 42 (for example a wire-mesh splashguard) which connects to lid 40. As in the embodiments shown above, splashguard 42 may be removed and separated from the top part of the lid, lid 40, for cleaning. In FIG. 7, splashguard 42 is placed on top of a custom pan—as compared to the cooking system shown in FIG. 5 where the splashguard is positioned below a custom pan/accessory. By positioning the splashguard above a pan, the splashguard may acts as splashguard, a steamer base/platform, and also as a drip base/platform for baking/broiling. An application useful when, for example, broiling a piece of meat in the oven and the user wishes to capture fat and juices from the cooking meat. In this case, the splashguard acts as the “grill” on which the meat is placed and the fat and juices from the cooked meat drip into the lower custom pan designed for the splashguard below. Another example is for baking, such as baking cookies, where the food item is placed on the splashguard and the lower pan captures crumbs and juices released from the food item during cooking—thus the pan may be used in the oven as well as on the stovetop for either baking or broiling. Additionally, placing a food item on the splashguard allows air to circulate around the baked item for even cooking. The lower pan may attach to the splashguard in a similar manner that the splashguard attaches to the lid and when assembled/attached together the cooking system is one piece; however, the splashguard may be used in conjunction with the pan without the corresponding lid piece (in other words the three components are attachable in various combinations with or without the splashguard, lid, or pan).

In operation, the disclosed cooking system provides attachable lid and splashguard components which may connected to manage amount of steam released from an item being cooked below the cooking system or in the vessel formed by the connected lid and splashguard components.

The foregoing description of the exemplary embodiments is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A cooking system for reducing splash and managing steam release while cooking a food item, comprising:
a lid comprising at least one lid opening portion, said lid opening portion comprising a handle and a hinge allowing said lid opening portion to be opened and closed;
a splashguard attached to said lid according to a locking device, said splashguard attaching below said lid;
said locking device operable for the separation and reattachment of said splashguard from said lid; and
a lid edge operable for secure placement on top of a cooking vessel.

2. The cooking system of claim 1, wherein said splashguard is a wire mesh splashguard.

3. The cooking system of claim 1, wherein said lid is a glass lid.

4. The cooking system of claim 1, wherein said opening portion opens inwardly and said handle is positioned approximate the periphery of said opening portion.

5. The cooking system of claim 1, wherein said opening portion opens outwardly and said handle is positioned approximate the center of said lid.

6. The cooking system of claim 1, wherein said opening portion opens in an accordion fashion.

7. The cooking system of claim 1, wherein said lid comprises two opening portions of approximately equal size and comprising approximately 50% of the lid area size.

8. The cooking system of claim 7, wherein said opening portions open inwardly and said handle is positioned approximate the periphery of said opening portions.

9. The cooking system of claim 7, wherein said opening portions open outwardly and said handle is positioned approximate the center of said lid.

10. The cooking system of claim 1, further comprising accessory positioned between said lid and said splashguard, said accessory acting as a heat pan for food items.

11. The cooking system of claim 10, wherein said accessory is a wooden insert.

12. The cooking system of claim 1, further comprising a baking/broiling pan attached to and below said splashguard, said baking/broiling pan also operable to attach to said lid

13. A cooking system for reducing splash and managing steam release while cooking a food item, comprising:
a lid comprising a two lid opening portions of approximately equal size and comprising approximately 50% of the lid area size, said lid opening portions each comprising a handle and a hinge allowing each of said lid opening portions to be opened and closed;
a splashguard attached to said lid according to a locking device, said splashguard attaching below said lid;
said locking device operable for the separation and reattachment of said splashguard from said lid;
a lid edge operable for secure placement on top of a cooking vessel; and
a accessory positioned between said lid and said splashguard, said accessory acting as a heat pan for food items.
